(19) United States
(12) Patent Application Publication
(10) Pub. No.: US 2010/0259614 A1
(43) Pub. Date: Oct. 14, 2010

(54) Delay Compensated Feature Target System

(75) Inventor: Ji Chen, Albuquerque, NM (US)

Correspondence Address: HONEYWELL/S&S;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/423,108

(22) Filed: Apr. 14, 2009

(51) Int. Cl. H04N 7/18; G06F 17/00

(52) U.S. Cl. 348/148; 701/2; 348/E07.085; 382/106; 382/169

(57) ABSTRACT

Apparatus and methods are provided for acquiring a target. A vehicle generates video frames that are sent to a control. The vehicle stores a subset of the frames. The vehicle may receive a lock message from the control that identifies a feature. Based on the information in the lock message, the vehicle may find a stored “fast-forward” frame with the feature, locate the feature on the fast-forward frame, determine a trajectory of the feature, and then determine a current location of the feature in a current frame. Once the vehicle has determined the current location of the feature, the vehicle may send a target acquired message to the control. An estimate of communication latency between the control and the vehicle may be determined. Then, the fast-forward frame may be determined based on a time of arrival of the lock message and the latency.

### GOVERNMENT LICENSE RIGHTS

The United States Government has certain rights to this invention under Contract No. W56HZV-05-C-0724 awarded by the US Army Tank Automotive and Armaments Command.

### BACKGROUND OF THE INVENTION

1. Field of the Invention

This invention relates to the field of unmanned vehicles. More particularly, this invention relates to delay-compensated targeting in weapon systems for unmanned vehicles.

2. Background

Unmanned vehicles, such as unmanned aerial vehicles (UAVs) and unmanned ground vehicles (UGVs), are widely used by the military/police, rescue, scientific, and commercial communities. One definition of a UAV is an unmanned device capable of controlled, sustained, and powered flight. A UGV may be defined as unmanned device capable of controlled, sustained, and powered ground travel. As such, the designs of UAVs and UGVs consist of aircraft and ground vehicles, respectively, of various sizes, capabilities, and weights. A typical UAV or UGV consists of a propulsion device, such as a turbine or engine, a navigation system, and one or more sensors. In some circumstances, the UAV or UGV may be equipped with one or more weapons.

As the UAV or UGV is unmanned, computer software executing on one or more processors aboard the UAV or UGV partially or completely controls the UAV or UGV. The one or more sensors may include one or more cameras. The camera(s) may provide one or more “video feeds” or streams of video images or “frames”. The UAV or UGV may transmit the video feed(s) to a control station. Each frame of a video feed may include one or “features” or items of interest, such as a missing person in a rescue scenario or a military vehicle in a combat scenario.

Some features may be mobile. FIG. 1 shows a scenario involving a mobile feature 10 that moves along path 20. When feature 10 is observed in a first frame 12, the feature 10 is located at position (x, y) toward the top of frame 12. After feature 10 moves along path 20, feature 10 is observed in frame 14 and located at position (a, b) toward the bottom of frame 14. Therefore, any designation of feature 10 with respect to first frame 12 (e.g., location at position (x, y) of frame 12) may not designate the feature in later frame 14. Indeed, as FIG. 1 shows, frame 14 is blank at position (x, y).

### SUMMARY

A first embodiment of the invention provides a vehicle. The vehicle includes a sensor, a transceiver, a processor, and data storage. The sensor is configured to generate a plurality of frames, including a current frame. The transceiver is configured to send the plurality of frames and messages and to receive messages. The data storage is configured to store at least a subset of the plurality of frames. The data storage stored machine-language instructions that are configured to instruct the processor to perform functions. The functions include: (a) storing a subset of the plurality of frames, including a fast-forward frame, (b) sending the plurality of frames, including the fast-forward frame, (c) receiving a lock message identifying a target feature, (d) determining that the lock message is associated with a fast-forward frame, (e) determining that the fast-forward frame is in the stored subset of frames, (f) determining a current location of the target feature in the current frame based on the determined target feature in the stored fast-forward frame, and (g) responsive to determining the current location of the target feature, sending a target-acquired message.

A second embodiment of the invention provides a method. A first frame of a plurality of frames is sent. A subset of the plurality of frames is stored. A lock message identifying a target feature is received. Based on the lock message, a fast-forward frame and a location of the target feature of the fast-forward frame are determined. A current location of the target feature based on the location of the target feature of the fast-forward frame is determined. Responsive to determining the current location of the target feature, a target-acquired message is sent.

### BRIEF DESCRIPTION OF THE DRAWINGS

Various examples of embodiments are described herein with reference to the following drawings, wherein like numerals denote like entities, in which:

FIG. 1 shows a scenario involving a mobile feature that moves along a path;

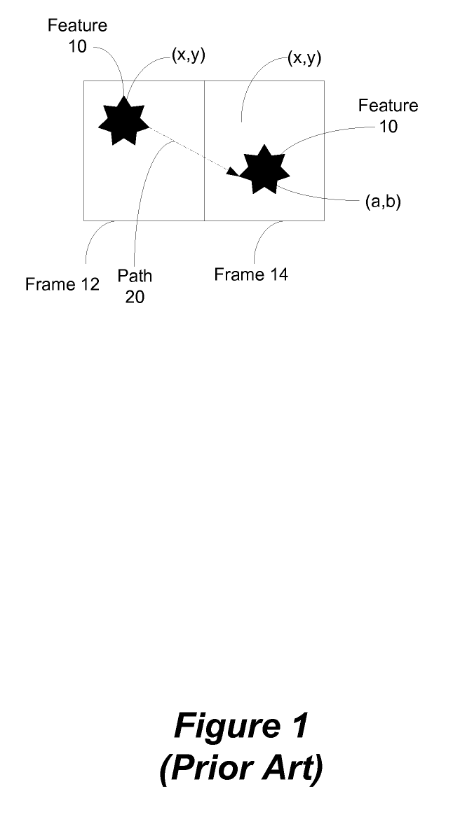

FIG. 2 shows an example UAV, in accordance with embodiments of the invention;

FIG. 3 shows an example UGV, in accordance with embodiments of the invention;

FIG. 4A shows a tracking system including a vehicle configured to communicate with a ground control, in accordance with embodiments of the invention;

FIG. 4B shows an example historical frame buffer arranged as a ring buffer, in accordance with embodiments of the invention;

FIG. 5 is a block diagram of an example computing device comprising a processing unit, data storage, a data-link interface, and a sensor interface, in accordance with embodiments of the invention;

FIG. 6A shows an example scenario of a vehicle operator observing a feature via a ground control, in accordance with embodiments of the invention;

FIG. 6B depicts an example message flows between the vehicle and the ground control 450, in accordance with embodiments of the invention;

FIG. 6C shows an example scenario for processing a lock command, tracking and interpolating a feature to generate a target-acquired message, in accordance with embodiments of the invention; and

FIG. 7 is a flowchart depicting an example method for processing commands, in accordance with embodiments of the invention.

### DETAILED DESCRIPTION

The present invention is directed to tracking “features” or targets at a vehicle. The vehicle generates a “video feed” or pluralities of frames or images and sends the video feed to a “ground control” or control, which is typically equipped with a display for displaying the video feed. An operator of the ground control may detect a feature and send a command to the vehicle to lock onto the feature.

A significant challenge in making such a tracking system functional is in dealing with the delays encountered between the time a frame is captured and the time an input from the user is issued to lock on to a region of interest in a particular frame. The ability of the system to correctly track the designated feature may be impaired by “latency”, or communication delays between the video capture sensor and the source of user input. For example, if the latency is longer than 100 ms (the time for about 3 frames in a 30 frame per second video feed) and the feature is moving at a relatively high velocity, the locking on to a feature may completely fail. In certain cases, erroneous feature tracking may occur if two similarly featured regions are present in the video frame and displacement of the feature from frame to frame is sufficiently large to cause confusion to the feature tracking software. One technique to estimate the latency is to use echo delay and echo request messages (a.k.a. PING messages) to calculate a round-trip delay and then divide the round-trip delay by two to estimate the latency for a one-way communication.

To correct for this source of error, some of the frames in the video feed may be buffered in a frame buffer. Then, when a lock command is received, the vehicle may search through the frame buffer to find the feature designated in the lock command. The search may be guided by an estimate of the latency. For example, if the latency is estimated at 100 ms and the video feed is generated at 40 frames/second (or 1 frame per 25 ms), the lock command may be estimated to refer to a frame that is 100 ms/(1 frame/25 ms)=4 frames before the current frame. Then, the search for the feature may locate a “fast-forward” frame that is 4 frames before the current frame. In other embodiments, the fast-forward frame may be identified using one or more frame identifiers in the lock message.

Once the fast-forward frame is located, a feature tracking algorithm, such as a gated-frame search or centroid-tracking estimation, may be used to determine a trajectory of the feature from frame to frame. Gated-frame searches may include determining an average pixel value A_{feat} over a region of the fast-forward frame that includes a pixel position of the feature (as specified in the lock message). Then, a successive frame to the fast-forward frame may be subdivided into regions and average pixel values determined for each region of the successive frame. The region of the successive frame with the same (or closest) average pixel value as A_{feat} is used as the location of the feature in the successive frame. This process continues until a region of the current frame is determined whose average pixel value best approximates or equals A_{feat}.

Centroid-tracking involves determining a shape of the feature. The shape of the feature may be determined using edge or region detection algorithms or by use of a bounding shape (e.g., polygon or circle) for the feature. Then, the center of mass or centroid of the feature is tracked along successive frames. Additional information about tracking algorithms may be found in Xun et al., “Applying TV Centroid Tracking Technology to Model 360 Laser TV Cinetheodolite”, National Air Intelligence Center, Wright-Patterson AFB Ohio, Mar. 4, 1996, which is incorporated herein by reference.

Once the vehicle locates the feature on the current frame, the vehicle may send a “target acquired” message to the control. The control may then request the vehicle follow or “track” the feature and/or fire one or more weapons at the feature (if the vehicle is so equipped). The control may ask the vehicle to stop tracking or “unlock” the feature as well.

The present invention can achieve greatly improved lock accuracy while at the same time provide an excellent opportunity for overall system cost reduction—as a relatively small amount of storage may compensate for a relatively large amount of delay. For example, assume that a video feed is made up of frames sent at 30 frames/second and that each frame may be stored in a 1 megabyte buffer. Then, the addition of 60 megabytes of storage may allow compensation for up to 2 seconds of latency. The present invention may therefore offer a much larger tolerance for latency and so latency may become a much less critical design parameter in any remote controlled feature target tracking system. Further, by use of latency estimation, frame identifiers need not be sent in a lock or other commands that may specifically identify frames (e.g., a command to retransmit a lost or garbled frame). However, if frame identifiers are sent but are garbled during transmission, the use of latency estimates to determine the fast forward frame may correct for the garbled identifier(s). Thus, the use of latency estimation as described herein may save bandwidth for and permit more robust processing of lock commands.

An Example UAV

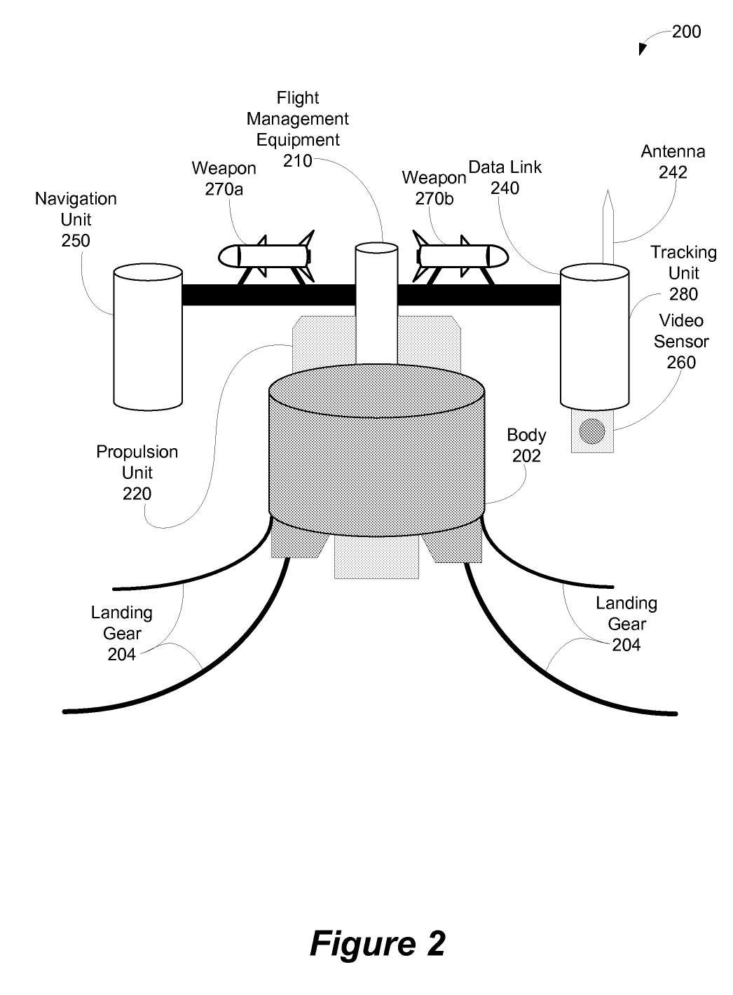

Turning to the figures, FIG. 2 shows an example UAV 200, in accordance with embodiments of the invention. FIG. 2 shows the UAV 200 with a body 202, landing gear 204, flight-management equipment 210, a propulsion unit 220, a data link 240 with an antenna 242, a navigation unit 250, and a navigation system 260.

For structural support and other reasons, the UAV 200 may have a body 202 and landing gear 204. The shapes of the body 202 and/or landing gear 204 shown in FIG. 2 are examples only and may vary. For example, the body 202 may have an aerodynamic shape, such as found in a body of a conventional manned aircraft. The landing gear 204 may or may not be retractable into the body 202.

The flight-management equipment 210 may provide guidance to the UAV 200, akin to the control provided by a human pilot in a manned aircraft. The flight-management equipment 210 may include flight controllers and/or servos (electromechanical devices) that control various flight-control surfaces of the UAV 200. For example, one or more servos may control a rudder or aileron(s) of the UAV 200. The flight-management equipment 210 may include a fan actuator, instead or as well. In particular, the flight-management equipment 210 may include computer hardware and/or software that implement control, take-off, flight and/or landing sequence(s) of the UAV 200, control any sensors and/or weapons aboard the UGV 300, and/or issue commands to retract or extract the landing gear 204 (if possible).

The propulsion unit 220 may provide power to move the UAV 200. The propulsion units may include one or more engines, fans, pumps, rotors, belts, and/or propellers. One or more engine control units (ECUs) and/or power control units (PCUs) may control the propulsion unit 220. For example, an ECU may control fuel flow in an engine based on data received from various engine sensors, such as air and fuel sensors. The propulsion unit 220 may have one or more fuel tanks, one or more fuel pumps to provide the fuel from the fuel tank(s) to the propulsion unit 220. The propulsion unit 220 may also include one or more fuel-level sensors to monitor the fuel tank(s).

The data link system 240 may permit communication between the UAV 200 and other devices. For example, the data link system may permit communication with other UAVs in use at the same time as the UAV 200. The data link system 240 may permit communication with one or more ground control devices (not shown). A UAV operator may guide and/or observe the UAV 200 using the one or more ground control devices, which may include sending commands, data, and/or receiving notifications from the UAV 200.

The data link system 240 may use one or more wireless communication devices, such as a radio and/or antenna 242, for communication. In an alternative not shown in FIG. 2, the data link system 240 may use one or more wired communication devices, perhaps while the UAV 200 is tethered to the ground.

The UAV 200 may have a navigation unit 250. The navigation unit 250 may navigational data, including location, velocity and/or acceleration data about the UAV 200. The navigational data may include about aircraft nearby the UAV 200. The navigation unit 250 may include other location devices configured to generate some or all of the navigational data, such as, but not limited to, magnetometers, gyroscopes, lasers, Global Positioning System (GPS) receivers, radars, altimeters, and other navigation components. The location devices may include additional sensors to provide additional data about the environment for the UAV 200, such as pressure sensors, thermometers, and/or other environment sensors.

FIG. 2 shows the UAV with a video sensor 260. In other embodiments, the UAV 200 may include more video sensors and/or other electromagnetic sensors (e.g., microwave detectors, infra-red scanner, ultra-violet sensor). The video sensor 260 may be a camera or other sensor configured to generate one or more “video feeds” or pluralities of frames or images. The video sensor 260 may generate the video feed(s) upon demand (i.e., as a plurality of still shots) and/or at a fixed “frame rate” e.g., 30 frames/second or 60 frames/second. The video feed(s) may be sent over the data link 240 and/or antenna 242. If the UAV 200 is equipped with multiple video sensors, each video sensor may generate separate video feed(s). The video sensor 260 may be configured to move along one or more degrees of freedom (e.g., along a horizontal line or a vertical line). For example, the video sensor 260 may mounted on two gimbals that permit the video sensor 260 to move along two degrees of freedom. The video sensor 260 may have a “zoom” capability that allows the sensor to increase or decrease magnification of frame(s) in a video feed.

FIG. 2 shows the UAV 200 equipped with weapons 270a and 270b. The weapons 270a and 270b may be, but are not limited to, missiles, rockets, mines, bombs, grenades, lasers, and/or guns. The weapons 270a and 270b also or instead may be training weapons, such as lasers or weapons equipped with dummy rounds and/or warheads. The weapons 270a and 270b may be and/or include one or more designators, such as laser designators, to “paint” or otherwise indicate a target with energy. Munitions, such as laser guided munitions, may then be fired by support troops at the designated target.

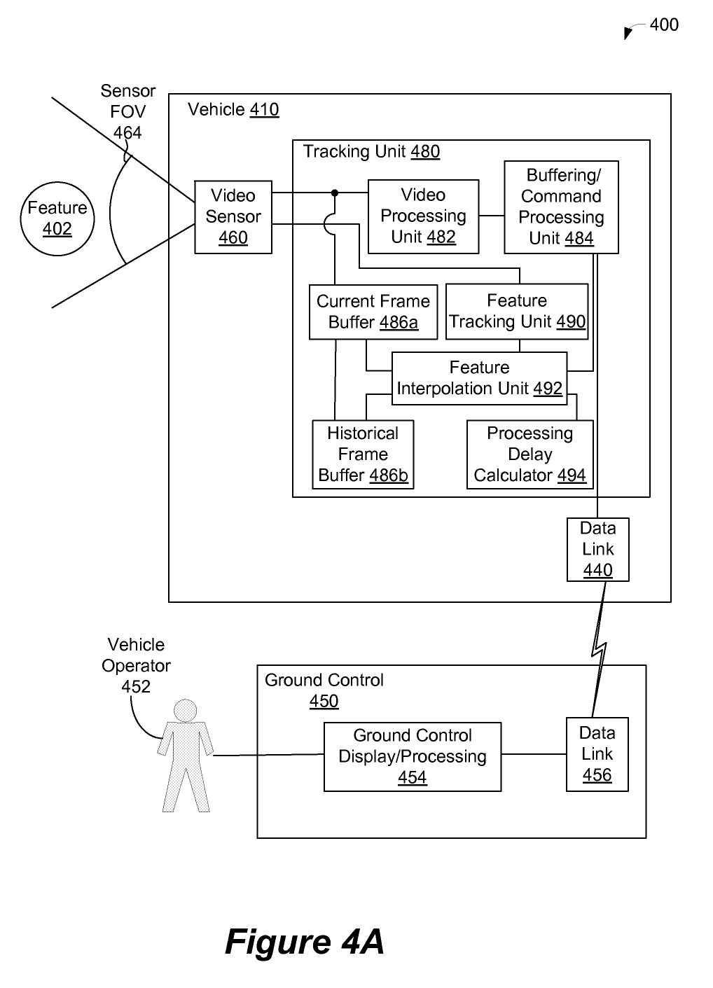

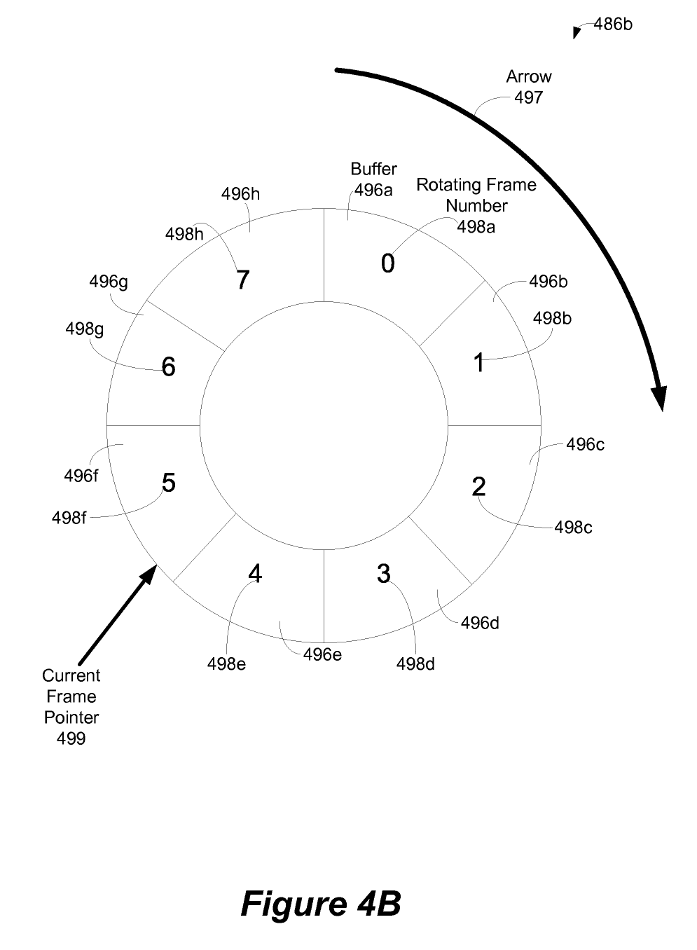

FIG. 2 shows the UAV 200 with a tracking unit 280, which is described in more detail with respect to FIG. 4 below.

An Example UGV

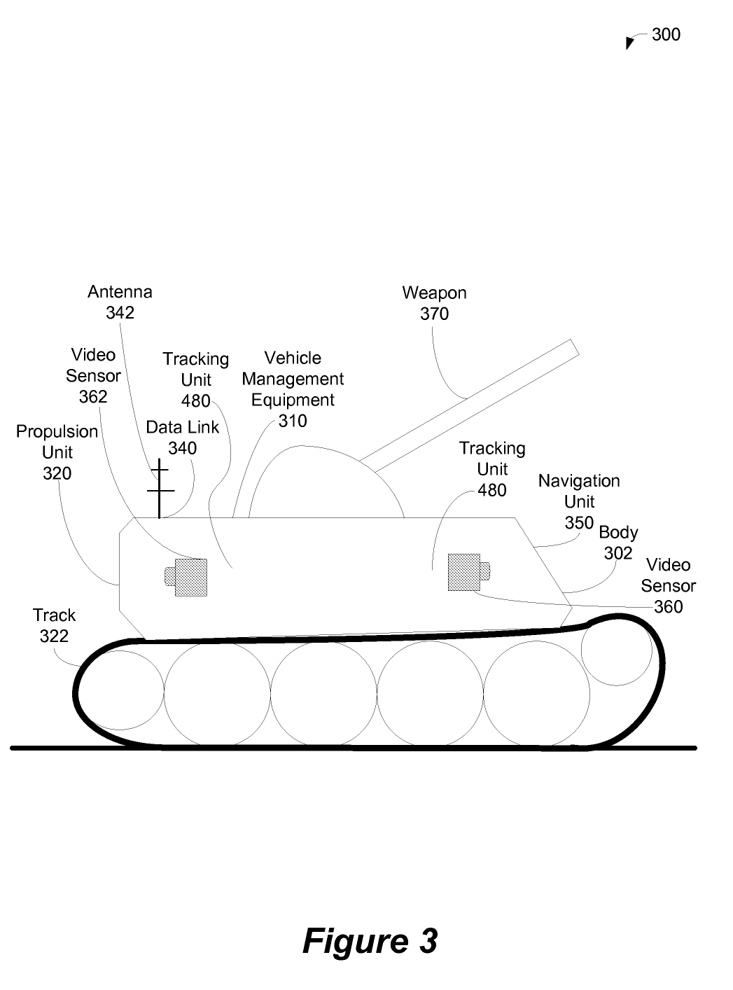

FIG. 3 shows an example UGV 300, in accordance with embodiments of the invention. FIG. 3 shows the UGV 300 with a body 302, vehicle-management equipment 310, a propulsion unit 320 with a track 322, a data link 340 with an antenna 342, and a navigation unit 350.

The shape of the body 302 is an example only and may vary. For example, the body 302 may be shaped as a car, cart, truck, van, or other ground vehicle. The vehicle-management equipment 310 may guide the UGV 300, akin to the control provided by a human driver in a manned ground vehicle. The vehicle-management equipment 310 may include servos configured to control vehicle-controls of the UGV 300. For example, one or more servos may control a steering wheel or brakes of the UGV 300. In particular, the vehicle-management equipment 310 may include computer hardware and/or software to start, drive and/or stop the UGV 300, as well as control any sensors and/or weapons aboard the UGV 300.

The propulsion unit 320 may provide power to move the UGV 300. The propulsion units may include one or more engines, turbines, fans, pumps, rotors, and/or belts. One or more engine control units (ECUs) and/or power control units (PCUs) may control the propulsion unit 320. For example, an ECU may control fuel flow in an engine based on data received from various engine sensors, such as air and fuel sensors. The propulsion unit 320 may have one or more fuel tanks, one or more fuel pumps to provide the fuel from the fuel tank(s) to the propulsion unit 320. The propulsion unit 320 may also include one or more fuel-level sensors to monitor the fuel tank(s). FIG. 3 shows the propulsion unit 320 configured to power a track 322 to move the UGV 300. In other embodiments, the propulsion unit 320 may be configured to power one or more wheels to move the UGV 300.

The data link system 340 may permit communication between the UGV 300 and other devices and use the antenna 342, perhaps with a UGV operator using a ground control, such as the data link system described above with respect to FIG. 2.

The UGV 300 may have a navigation unit 350 that may generate navigational data, including data about other vehicles near to the UGV 300, and use location devices and (additional) sensors such as the navigational system described above with respect to FIG. 2.

FIG. 3 shows UGV 300 with video sensors 360 and 362. In other embodiments, the UGV 300 may have more or fewer video sensors and/or have other electromagnetic sensors, such as described above with respect to FIG. 2. Each video sensor 360, 362 may generate and/or send video feed(s), move along degree(s) of freedom, and/or have a zoom capability, such as described above with respect to FIG. 2.

FIG. 3 shows the UGV 300 with a weapon 370. The UGV 300 may carry one or more munitions for use with weapon 370 (e.g., artillery shells or small-weapons rounds). In other embodiments, the UGV 300 may be equipped with more, fewer, and/or other weapons, such as those described above with respect to FIG. 2. The weapon 370 also or instead may be a training weapon, such as lasers or loaded with dummy munitions (a.k.a. blanks). The weapon 370 may be and/or include a designator such as described above with respect to FIG. 2.

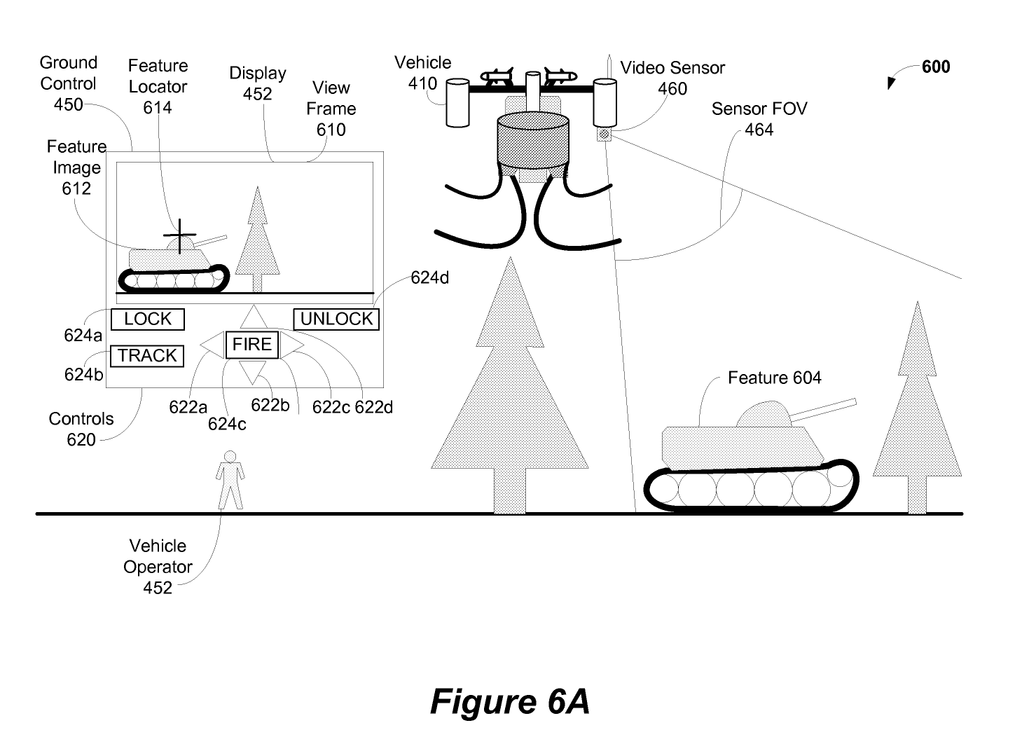

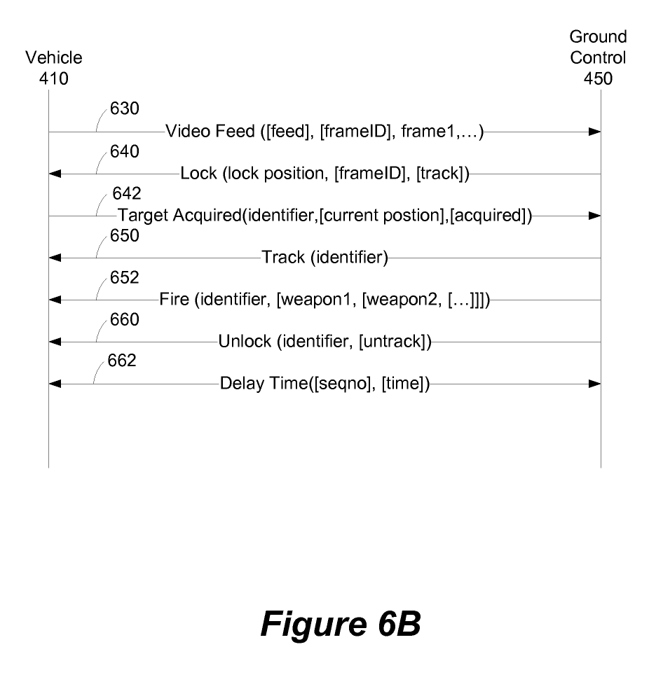

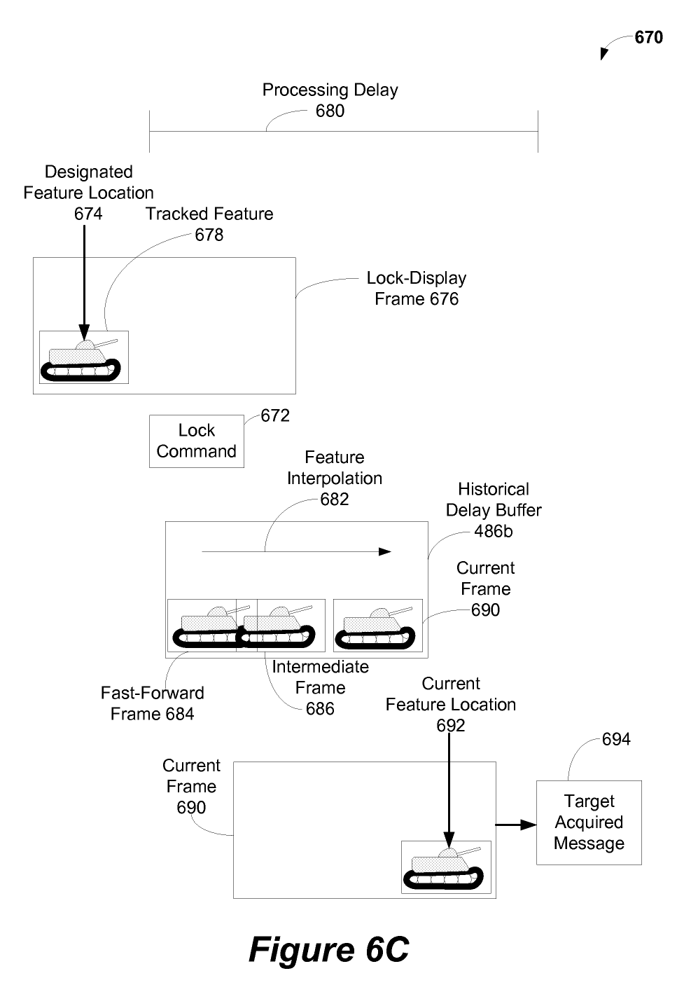

FIG. 3 shows the UGV 300 with a tracking unit 480 for each video sensor 460 and 462. The tracking unit 480 is described in more detail with respect to FIGS. 4A, 4B, 6A, and 6C below.

An Example Tracking System

FIG. 4A shows a tracking system 400 with a vehicle 410 configured to communicate with a ground control 450, in accordance with embodiments of the invention. The vehicle 410, which may be a UAV such as described above with respect to FIG. 2 or a UGV such as described with respect to FIG. 3, may have a video sensor 460, a tracking unit 480, and a data link 440. The data link 440 and the video sensor 460 may be a data link and a video sensor, respectively, such as described above with respect to FIG. 2.

The data link 440 may permit communication with a data link 456 of the ground control 450. A vehicle operator 462 may operate the ground control 450. The ground control 450 may include a display and processing unit 454. As such, the ground control may be configured to send commands to the vehicle 410 and to receive one or more video feeds and/or other information from the vehicle 410. Additional features of the ground control 450 are described with respect to FIG. 6A below.

The video sensor 460 may capture one or more frame with image(s) of object(s) within its field of view (FOV) 464, perhaps including images of feature 402, at a given “frame rate” or number of frames per unit time (e.g., frames/second). After the video sensor 460 captures a frame, the captured frame may be processed by video processing unit 482. The video processing unit may compress and/or otherwise process the captured frame. Examples of other processing of the captured frame may include, but are not limited to, changing contrast and/or lighting of the frame, cropping or clipping the frame, locating features within the frame, and adding framing information such as a frame number and/or time stamp to the frame. The processed frame may be sent from the video processing unit 482 to the buffering/command processing unit 484. The buffering/command processing unit 484 may then send the processed frame to the data link 440 for transmission to the ground control 450. Thus, a video feed of images captured from the video sensor 460 may be sent as a plurality of processed frames at the frame rate to the ground station 450.

The ground control 450 may display each received frame of the video feed. For example, a display of the ground control display/processing unit 454 may display a “display frame” or most-recently received frame (i.e., current frame) of the video feed. The display frame and all other frames of the video feed may be made up of an X by Y grid of pixels, each pixel representing the smallest displayable element of the display frame. Then, a location on the display or “pixel position” may be specified as an (x, y) value, where 0≦x<X and 0≦y<Y. The vehicle operator 452 may identify a feature, such as feature 402, by specifying one or more pixel locations of the feature 402 on the display frame.

The captured frame may also be stored in a current frame buffer 486a and/or historical frame buffer 486b. The current frame buffer 486a may be a memory device (e.g., random access memory (RAM), flash memory, bubble memory, cache memory) configured to store at least one frame. The historical frame buffer 486b may also be a memory device configured to store at least one frame that has been previously captured by the video sensor 460. The stored frames may be as captured from the video sensor (as shown in FIG. 4A) or the processed frames (not shown in FIG. 4A) after processing by the video processing unit 482 (i.e., uncompressed). In some embodiments, the current frame buffer 486a and the historical frame buffer 486b may be implemented using a common memory device. Preferably, at least the historical frame buffer 486b is located very close to the video sensor 460 to minimize processing delays between the video sensor 460 and the historical frame buffer 486b.

If the vehicle 410 is equipped with multiple video sensors 460, the vehicle may also be equipped with multiple tracking units 480. Example locations for a memory device for the historical frame buffer 486b are a video processing board connected to the video sensor 460 or a memory coupled to or part of a processor controlling the video sensor 460. The historical frame buffer 486b is also discussed in more detail below with respect to FIG. 4B.

The ground control 450 may send one or more commands to the vehicle 410, perhaps as directed by the vehicle operator 452. Example commands may include a lock command, a track command, an unlock command, and a fire command. These example commands are discussed in more detail below with respect to FIG. 6B. The ground control 450 may send a command to the vehicle 450 via data link 456 and data link 440. At reception at data link 440, the command may be sent to the buffering/command processing unit 484 of the tracking unit.

At the buffering/command processing unit 484, a command type of the command may be determined. Example command types are lock commands, unlock commands, track commands, and fire commands. Many other command types are possible as well.

If the command is a lock command, the buffering/command processing unit 484 may determine a lock position based on the lock command. The lock position may be specified as a pixel position on the display frame. The lock command may also specify a frame identifier as well. The frame identifier may be a number, letter, or alphanumeric sequence specifying a frame, a time the frame was sent, a time the frame was received, or some other data that identifies a frame. The frame identifier may have other information as well, such as a vehicle identifier and/or a video feed identifier. For example, the frame identifier may be a number such as “6” or “16890”, an alphanumeric sequence such as “UAV33_Feed1_Frame16890”, or a time when the frame was sent (or received) such as “21:39:03.0500 2009/03/21”.

The tracking unit 480 may be able to determine a “fast-forward frame” or frame stored in the current frame buffer 486a and/or the historical frame buffer 486b corresponding to the display frame. If the lock command includes a frame identifier, the buffering/command processing unit 484 may send the lock position and, if received, the received frame identifier to the feature interpolation unit 492. The feature interpolation unit 492 may use the lock position and the frame identifier to find the fast-forward frame in the historical frame buffer 486b; for example, by performing a table or database lookup using part or all of the frame identifier as a key value and, if the key value is found, retrieving the corresponding stored frame as the fast-forward frame. An example implementation of the historical frame buffer 486b using rotating frame identifiers is discussed with respect to FIG. 4B below.

The feature interpolation unit 492 may be able to determine which stored frame is the fast-forward frame based on the delay or “latency” of transmissions between the vehicle 410 and the ground control 450. Preferably, a “latency resolution” or error in the determined latency of the detection system is finer than the frame rate for the video feed. For example, if the frame rate is 30 frames/second, a latency resolution of less than 33.3 milliseconds resolution may locate the correct video frame while compensating for delay. The tracking unit 480 may advantageously use the latency to determine the fast-forward frame in various operational conditions, such as when frame identifiers are not part of the lock command and/or when a received frame identifier is erroneous.

An example synchronization algorithm is to periodically send and receive Internet Control Message Protocol (IMCP) echo request and echo reply messages, respectively, (a.k.a. ping messages) from a sender (i.e., the vehicle 410) to a destination (i.e., the ground control 450). At the destination, the ping message is returned to the sender of the ping message. Then, the sender may determine the round-trip delay by: RTD=T_{receive}—T_{send}, where RTD is the round trip delay, T_{receive} is the time when the return ping message is received, and T_{send} is the time when the ping message was sent. Echo requests and echo replies are described in more detail in J. Postel, “Internet Control Message Protocol”, Request for Comments (RFC) 792, September, 1981 (“RFC 792”), available at http://tools.ietf.org/html/rfc792 (last visited Mar. 27, 2009) and A. Conta et al., “Internet Control Message Protocol (ICMPv6) for the Internet Protocol Version 6 (IPv6) Specification”, RFC 4443, March 2006, available at http://tools.ietf.org/html/rfc4443 (last visited Mar. 27, 2009). Both RFC 792 and RFC 4443 are incorporated herein by reference.

The one-way latency L may then be estimated by L=RTD/2, as there are two communication legs (from the vehicle to the ground and from the ground to the vehicle) in the round-trip and the latency is related to one communication.

Another example synchronization algorithm is to use the Network Time Protocol (NTP) and/or Simple NTP (SNTP) to synchronize a common clock between the vehicle 410 and the ground control 450. NTP is described in more detail in D. Mills, “Network Time Protocol (Version 3) Specification, Implementation, and Analysis”, RFC 1305, March 1992, available at http://tools.ietf.org/html/rfc1305 (last visited Mar. 22, 2009) (“RFC 1305”). SNTP is described in more detail in D. Mills, “Simple Network Time Protocol (SNTP) Version 4 for IPv4, IPv6 and OSI”, RFC 4330, January 2006, available at http://tools.ietf.org/html/rfc4330 (last visited Mar. 22, 2009) (“RFC 4330”). Both RFC 1305 and RFC 4330 are incorporated herein by reference.

Then, using NTP or SNTP, the clocks on the vehicle 410 and the ground control 450 can be synchronized (e.g., within a few milliseconds). At the time of each frame capture, the video sensor 460 and/or the tracking unit 480 in the vehicle 410 may associate a fixed time or “time stamp” (Time Stamp 1) with the frame. The ground control 450 may associate a second time stamp (Time Stamp 2) with the time when a lock command is sent to the vehicle 410 and may send Time Stamp 2 with the lock command. The vehicle 410 may record another time stamp (Time Stamp 3) upon reception of the lock command. The sum of differences between Time Stamp 2 and Time Stamp 1, and Time Stamp 3 and Time Stamp 2 produces the “round-trip” or end-to-end processing delay experienced by the system. In another embodiment, the vehicle 410 and the remote control 450 may synchronize their on-board time to a good common time source such as one or more Global Positioning System (GPS) satellites, rather than use NTP or SNTP.

The processing delay calculator 494 may provide one-way latency and/or a round-trip delay value(s) to the feature interpolation unit 492 to estimate which buffer in the historical frame buffer 486b is the stored-display buffer. For example, suppose the one-way latency is determined to be 100 milliseconds (=0.1 seconds) by the processing delay calculator 494 and that 30 frames/second are generated by the video sensor 460 and stored in the historical frame buffer 486b. When a lock command is sent from the ground control 450 to the vehicle, the feature interpolation unit 492 may query the processing delay calculator 494 for the one-way latency value, the processing delay calculator 494 may provide the 0.1 second estimate of the one-way latency to the feature interpolation unit 494, and then the processing delay calculator may estimate the number of frames between the current frame and the frame displayed on the ground control 450 at the time the lock command was sent by the formula: F=L*FR, where F=the number of frames, L=the one-way latency, and FR=the frame rate. For this example: F=0.1 seconds*30 frames/second=3 frames. In this example, the feature interpolation unit may go back F (or three) frames from the current frame to attempt to locate the frame used for the lock command. If the one-way latency is less than one-half of the frame rate (e.g., less than 16.6667 milliseconds when the frame rate is 30 frames/second=33.3333 milliseconds), the feature interpolation unit 492 may use the current frame as the fast-forward frame.

FIG. 4B shows an example historical frame buffer 486b arranged as a ring buffer, in accordance with embodiments of the invention. The ring buffer may be associated with rotating frame numbers to every video frame captured. FIG. 4B shows that eight frames may be stored in historical frame buffer 486b in eight buffers 496a, 496b, 496c, 496d, 496e, 496f, 496g, and 496h numbered 0 through 7. The arrow 497 shown in FIG. 4B indicates that the rotating frame numbers 498a, 498b, 498c, 498d, 498e, 498f, 498g, and 498h, associated with the buffers 496a-496h, respectively, increase until they reach the maximum number (7) and then reset to 0. In other embodiments, the frame numbers may decrease from the maximum number down to zero and reset to the maximum number (i.e., arrow 497 may go in the opposite direction). The rotating frame numbers 498a-498h may be used as frame identifiers between the vehicle 410 and the ground control 450. For example, to refer to buffer 496a, the vehicle 410 or ground station 450 may use the frame identifier “0”.

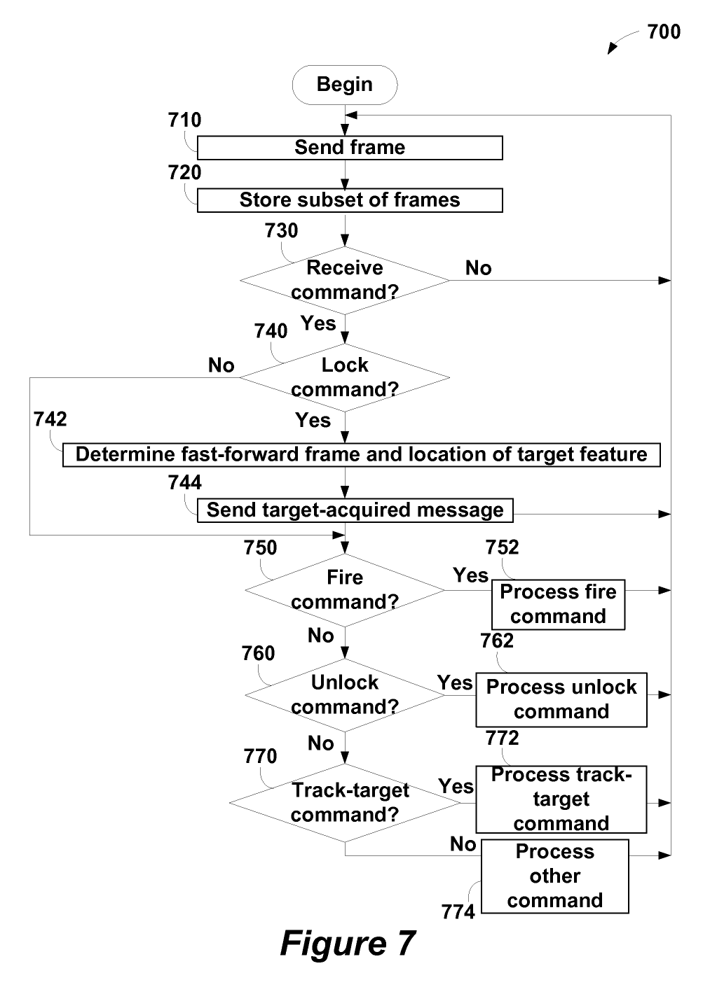

The historical frame buffer 486b may be long enough to accommodate the longest expected processing delay, such as described below with respect to FIG. 7. In other embodiments, the historical frame buffer 486b may have more or fewer than the eight buffers shown in FIG. 4b.

The use of a ring buffer may permit combination of the current frame buffer 486a and the historical frame buffer 486b. FIG. 4a shows a current frame pointer 499 pointing to buffer 496f identified with rotating frame number 498f of “5”. Upon reception at the historical frame buffer 486b of a frame from the video sensor 460 and/or the video processing unit 492, the buffer may be stored at in the buffer pointed to by current frame pointer 499. Note that current frame buffer 486a may remain uncombined with the historical frame buffer 486b by configuring the historical frame buffer 486b to receive a frame from the current frame buffer 486a instead of from the video sensor 460 and/or video processing unit 482.

After the received frame is stored, the current frame pointer 499 may be updated (i.e., incremented or decremented) to point to the next buffer. For example, if the current frame pointer 496 is updated to go in the direction of arrow 497, the current frame pointer 499 will be incremented to point to buffer 496g (e.g., buffer “6”) after a frame is stored in buffer 496f. If, after updating, the current frame pointer 499 points to an buffer beyond the maximum rotating frame number (e.g., 7), the current frame pointer 499 may be reset to point at the buffer with the minimum rotating frame number (e.g., 0). Conversely, if the current frame pointer 499 points to an buffer less than the minimum rotating frame number (e.g., 0), the current frame pointer 499 may be reset to point at the buffer with the maximum rotating frame number (e.g., 7) as described above.

In operation, upon identifying a feature, such as feature 402 of FIG. 4, the rotating frame number may be sent by the ground control 450 as part of the lock command to the vehicle. Upon reception of the lock command by the vehicle 410, the rotating frame number, used as a frame identifier, may index into the historical frame buffer 486b where the feature interpolation system will start processing the data.

An Example Computing Device

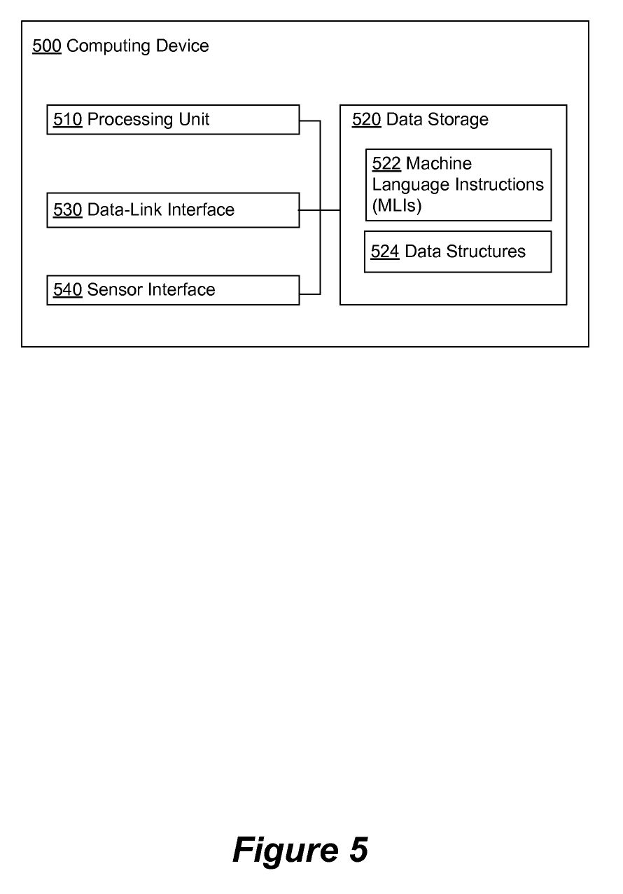

FIG. 5 is a block diagram of an example computing device 500 comprising a processing unit 510, data storage 520, a data-link interface 530, and a sensor interface 540, in accordance with embodiments of the invention. The computing device 500 is preferably a light-weight embedded processor, but may be a desktop computer, laptop or notebook computer, personal data assistant (PDA), mobile phone, or any similar device that is equipped with a processing unit capable of executing machine-language instructions that implement at least part of the herein-described method 800, described in more detail below with respect to FIG. 8, and/or herein-described functionality of a computing device, a ground control, a tracking system, tracking unit, flight-management equipment, vehicle-management equipment, video sensor, weapon, a navigation system, and/or a data link.

The processing unit 510 may include one or more central processing units, computer processors, mobile processors, digital signal processors (DSPs), microprocessors, computer chips, and similar processing units now known and later developed and may execute machine-language instructions and process data.

The data storage 520 may comprise one or more storage devices. The data storage 520 may include read-only memory (ROM), random access memory (RAM), removable-disk-drive memory, hard-disk memory, magnetic-tape memory, bubble memory, cache memory, flash memory, and similar storage devices now known and later developed. The data storage 520 comprises at least enough storage capacity to contain machine-language instructions 522 and data structures 524.

The machine-language instructions 522 and the data structures 524 contained in the data storage 520 include instructions executable by the processing unit 510 and any storage required, respectively, to perform some or all of the herein-described functions of computing device, a ground control, a tracking system, tracking unit, flight-management equipment, vehicle-management equipment, video sensor, weapon, a navigation system, and/or a data link, and/or to perform some or all of the procedures described in method 800.

The data-link interface 530 may be configured to send and receive data over a wired-communication interface and/or a wireless-communication interface. The wired-communication interface, if present, may comprise a wire, cable, fiber-optic link or similar physical connection, such as a USB, SCSI, Fire-Wire, and/or RS-232 connection, to a data network, such as a wide area network (WAN), a local area network (LAN), one or more public data networks, such as the Internet, one or more private data networks, or any combination of such networks. A UAV, such as UAV 200, may be tethered to the ground before utilizing the wired-communication interface of the data-link interface 530.

The wireless-communication interface, if present, may utilize an air interface, such as a Bluetooth™, ZigBee, Wireless WAN (WWAN), Wi-Fi, and/or WiMAX interface to a data network, such as a WWAN, a Wireless LAN, one or more public data networks (e.g., the Internet), one or more private data networks, or any combination of public and private data networks. In some embodiments, the data-link interface 530 is configured to send and/or receive data over multiple communication frequencies, as well as being able to select a communication frequency out of the multiple communication frequency for utilization. The wireless-communication interface may also, or instead, include hardware and/or software to receive communications over a data-link via an antenna, such as the antenna 242 or 342.

The sensor interface 540 may permit communication with one or more sensors, including but not limited to the video sensors and sensors needed by or described as a propulsion unit, navigation unit, location devices, flight-management equipment, and/or vehicle-management equipment as described above with respect to FIGS. 2 and 3.

Example Feature Tracking Scenarios and Message Flows

FIG. 6A shows an example scenario 600 of a vehicle operator 452 observing a feature 604 via ground control 450, in accordance with embodiments of the invention. FIG. 6A shows the vehicle operator 452 communicating with the vehicle 410 using the ground control 450. The vehicle 410 uses the video sensor 460 to observe the environment within the sensor FOV 464. The vehicle 410 sends a video feed to the ground control 450. The ground control 450 displays the current or view frame 610 of the video feed on display 452. FIG. 6A shows the view frame 610 with a feature image 612; that is an image of feature 604 and with a feature locator 614. The feature locator 614 may indicate a current position of interest to the vehicle operator 452.

FIG. 6A shows the ground control 450 with controls 620 configured to allow the vehicle operator 452 to operate the ground control 450. The feature locator 614 may be moved on the display using directional arrows 622a (to move left), 622b (to move down), 624c (to move right) and 624d (to move up). The vehicle operator 452 may send commands to the vehicle using lock button 624a, track button 624b, fire button 624c, and unlock button 624d. The display indicate the status of a feature as well. For example, suppose feature 604 was locked on by ground control 450 and vehicle 410. Then, the feature image 612 may change to indicate the locked status, such as but not limited to, being outlined with a rectangle, designated with an identifier, and/or backlit with a different color. Other interfaces move or use a feature locator and/or send commands are possible as well, such as but not limited to a touch screen, mouse, stylus, and/or keyboard interfaces.

FIG. 6B depicts an example message flows between vehicle 410 and ground control 450, in accordance with embodiments of the invention. The video feed 630 may indicate a possible message flow of frames in a video feed from the vehicle 410 to the ground control 450. The video feed may have a feed number or other identifier. If the feed number or other identifier is provided, the feed number or identifier may be sent upon initialization of the video feed 630, periodically, once per frame, upon request from the ground control, or using some other method. Frame identifiers, such as discussed above with respect to FIGS. 4A and 4B, may be sent in the video feed 630 as well. Upon reception of the video feed 630, the ground control may display the frames of the video feed 630.

The ground control 640 may send a lock command 640 to the vehicle. The lock command 640 may include a lock position, such as described above with respect to FIG. 4A. The lock command 640 may optionally include a frame identifier, such as discussed above with respect to FIGS. 4A and 4B. FIG. 6B shows optional information in square brackets. A video-feed identifier may be sent in the lock command as well. The vehicle may process the lock command as described above with respect to FIGS. 4A and 4B and as discussed below with respect to FIG. 6C.

In response to the lock command 640, the vehicle 410 may send a target-acquired message 642 to the ground control 450. The target-acquired message 642 may include an identifier for the feature targeted at the lock position of the lock command. For example, the identifier may be a number such as “1” or a current position for the feature. If the current position is not the identifier, the current position for the feature may be sent as well with the target-acquired message. The target-acquired message 642 may optionally include an “acquired” value or flag set to “Yes” when the target has been acquired or “No” if the vehicle 410 failed to acquire the target.

The ground control 410 may send a track message 650 to vehicle 410. The track message may include an identifier to track. The identifier may be as described above with respect to the target-acquired message 642. The track message 650 may indicate that the position of sensors aboard the vehicle 410 should move to follow the feature identified by the identifier. The track message may indicate as well that the vehicle 410 should follow the feature identifier by the identifier. Tracking may be performed implicitly by the vehicle 410 upon lock command 640, or may be indicated as an optional “track” flag with the lock command 640, or upon the reception of the track message 650.

The ground control 410 may send a fire message 652 to vehicle 410. The fire message 642 may include an identifier, such as an identifier described above with respect to the target-acquired message 642. The fire message 652 may optionally designate one or more weapons to be fired. The weapon designation may be a numeric, alphabetic, or alphanumeric indicator, to be fired; e.g., 22, “Gun1”, or “Missile”. Upon reception of the fire message 652, the vehicle may fire one or more weapons, including any designated weapons.

The ground control 410 may send an unlock message 660 to vehicle 410. The unlock message 660, may include an identifier, such as an identifier described above with respect to the target-acquired message 642, to identify a feature. Upon reception of the unlock message 660, the vehicle 410 may indicated the identified feature is no longer locked or acquired. Also, the unlock command may optionally include an “untrack” flag set to “Yes” if the vehicle 410 is not to track the identified feature or “No” if the vehicle 410 is to maintain tracking of the identified feature.

The delay time message 662 may be sent by either the vehicle 410 or the ground control 450. In response, the receiver of the message should echo the delay time message 662 to the sender. The delay time message 662 may optionally include a “seqno” or sequence number and/or timing information, such as a time when the delay time message 662 was sent. The delay time message 662 and reply to the delay time message 662 may be respectively be an echo request and an echo reply, such as described above with respect to FIG. 4A.

In addition, for each message described herein, additional information may be sent as well, such as, but not limited to, header and footer information, packet/message sequencing information, encapsulation header(s) and/or footer(s), size/time information, and transmission verification information such as cyclic redundancy check (CRC) and/or parity check values. The messages may be segmented and/or “piggybacked” onto other messages. The messages may be sent using security measures such as one or more encryption/decryption algorithms, or without use of security measures.

FIG. 6C shows an example scenario 670 for processing a lock command 672, tracking and interpolating a feature to generate a target-acquired message 694, in accordance with embodiments of the invention. The scenario 670 begins with lock-display frame 676 being sent to ground control 450. The lock-display frame 676 include a feature 678 at a designated feature location 674.

After receiving the lock-display frame 676, the ground control 450 may send a lock command 672 to a vehicle. The lock command may be a lock command as described above with respect to FIGS. 4A, 4B, and 6B. The lock command may include the designated feature location 674 as a lock position and optionally a frame identifier.

Upon reception of the lock command, the feature interpolation unit 492 may determine the fast-forward frame 684 (which corresponds to the lock-display frame 676) as described above with respect to FIG. 4A. Then, the feature interpolation unit 492 may use information from pixels located at the lock position (which corresponds to the designated feature location 674) of the fast-forward frame 684 to locate the feature on the fast-forward frame and/or detect a trajectory of the feature from the fast-forward frame 684, through one or more intermediate frames 686, to the current frame 690. Processing for feature interpolation 682 or “fast forwarding” through the stored frames 684, 686, and 690 may require a small amount of pixel processing for each stored frame. Thus, a small amount of processing (and therefore time) may be needed to track the feature from the fast-forward frame 684 to the current frame 690. One or more feature tracking algorithms may be utilized by feature tracking unit 490, such as the gated value or centroid tracking estimation algorithms described above, to track the feature between successive frames leading up to the current frame 690. The feature interpolation unit 492 may provide a current feature location 692 within the current frame 690 (perhaps as stored in the current frame buffer 486a) to the feature tracking unit 490 to be used as an input for the feature tracking algorithm(s). The tracked feature 678 may be tracked between the time of user input (i.e., sending of the lock command 672) and the time of capture of the current frame 690, eliminating the effects of processing delay 680 and ensuring proper locking of the designated feature 674.

As shown in FIG. 6C, a target-acquired message 694 is sent upon determination of the current feature location 692. The target-acquired message 694 may be as described above with respect to FIGS. 4A, 4B, 6A, and 6B. The target-acquired message 694 may be sent to the ground control 450 and may include information, such as the current feature location 692, about the tracked feature 678.

The trajectory and/or current feature location 692 may be used to control the video sensor; for example, the feature interpolation unit 492 may send commands to the video processing unit 482 to adjust the video sensor 460 so that a moving tracked feature stays within the sensor FOV 464. For example, if the trajectory of the tracked feature 678 indicates that the tracked feature 678 is moving left, the feature interpolation unit 492 may send one or more commands to the video processing unit 482 to move the video sensor 460 left as well, perhaps by commanding movement of gimbals of the video sensor 460. The amount of movement for the video sensor 460 may be based on the trajectory—for example, if the trajectory indicates that the tracked feature 478 is moving left across approximately 10% of each successive frame, the feature interpolation unit 492 may instruct the video sensor 460 to “pan” or move left corresponding to an amount of 10% of each successive frame. Similarly, the feature interpolation unit 492 may provide commands to move the vehicle 410 to keep the tracked feature 678 in the sensor FOV 464.

The feature interpolation unit 492 may also or instead send commands to adjust video features of the video sensor 460, such as zoom amount (e.g., zoom in or zoom out), contrast, coloration, and/or frequency filters if available to the video sensor 460 (e.g., apply or remove an infra-red or ultra-violet frequency filter).

Example Method for Processing Commands

FIG. 7 is a flowchart 700 depicting an example method for processing commands, in accordance with embodiments of the invention. It should be understood that each block in this flowchart and within other flowcharts presented herein may represent a module, segment, or portion of computer program code, which includes one or more executable instructions for implementing specific logical functions or steps in the process. Alternate implementations are included within the scope of the example embodiments in which functions may be executed out of order from that shown or discussed, including substantially concurrently or in reverse order, depending on the functionality involved, as would be understood by those reasonably skilled in the art of the described embodiments.

Method 700 begins at block 710. At block 710, a frame may be sent. The frame may sent by a vehicle, such as a UAV or a UGV, and may be captured by a video sensor. The frame may be one of a plurality of frames sent at a frame rate. The frame may be sent to a ground control.

At block 710, the frame may be stored. The frame may be stored in a current frame buffer and/or a historical frame buffer. The contents of the current frame buffer may be stored in the historical frame buffer. The current frame buffer and/or a historical frame buffer may store a subset of the frames sent. The subset may consist of a number of most recently sent frames. The number of the most recently sent frames may be based on a maximum latency estimate of communications between the vehicle and the ground control. For example, if the maximum latency estimate of communications is two seconds, the number of most recently sent frames may be equal to or greater than the number of frames sent within two seconds. Continuing the example, if the frame rate is 30 frames per second, the number or most recently sent frames may be two seconds*30 frames per second=60 frames and thus the current frame buffer and/or historical frame buffer may be configured to store at least 60 frames in this example.

At block 730, a determination is made as to whether a command is received. If a command is received, method 700 may proceed to block 740. If a command is not received, method 700 may proceed to block 710.

At block 740, a determination is made as to whether the received command is a lock command. The lock command may be as described above with respect to FIG. 6B. If the received command is a lock command, method 700 may proceed to block 742. If the received command is not a lock command, method 700 may proceed to block 750.

At block 742, a fast-forward frame and a location of a feature targeted in the lock command may be determined. The feature targeted in the lock command may be indicated using a lock position of the lock command. Determination of the fast-forward frame and the location of the feature targeted in the lock command may be as described above with respect to FIGS. 4A, 4B, 6A, 6B, and 6C.

At block 744, a target-acquired message may be sent. The target-acquired message may be as described above with respect to FIGS. 4A, 6A, 6B, and 6C. Thus the lock command may be processed using the procedures of blocks 742 and 744.

At block 750, a determination is made as to whether the received command is a fire command. If the received command is a fire command, method 700 may proceed to block 752. If the received command is not a lock command, method 700 may proceed to block 760.

At block 752, the fire command is processed. In particular, a weapon may be fired by the vehicle upon reception of the fire command. Additional details of the fire command and processing of the fire command are described above with respect to FIG. 6B.

At block 760, a determination is made as to whether the received command is an unlock command. If the received command is an unlock command, method 700 may proceed to block 762. If the received command is not an unlock command, method 700 may proceed to block 770.

At block 762, the unlock command is processed. Details of the unlock command and processing of the unlock command are described above with respect to FIG. 6B.

At block 770, a determination is made as to whether the received command is a track command. If the received command is a track-target command, method 700 may proceed to block 772. If the received command is not a track command, method 700 may proceed to block 774.

At block 772, the track command is processed. Details of the track command and processing of the track command are described above with respect to FIG. 6B.

At block 774, other commands are processed. If the other command is an echo reply or echo request message, the processing may be as described above with respect to FIGS. 4A and B. If the other command is unrecognized by or deemed to be invalid by the receiver of the other command, an indication of an invalid or unrecognized command may be sent to the sender of the other command. Alternatively, an invalid or unrecognized command may be silently ignored.

The method 700 may end upon a determination that there are no more frames to send and/or upon reception of a command, such as a “stop” or “shutdown” command. The stop/shutdown command may be processed in block 774 by powering down the receiver of the stop/shutdown command (and perhaps landing the receiver, if the receiver is an flying UAV).

### CONCLUSION

Exemplary embodiments of the present invention have been described above. Those skilled in the art will understand, however, that changes and modifications may be made to the embodiments described without departing from the true scope and spirit of the present invention, which is defined by the claims. It should be understood, however, that this and other arrangements described in detail herein are provided for purposes of example only and that the invention encompasses all modifications and enhancements within the scope and spirit of the following claims. As such, those skilled in the art will appreciate that other arrangements and other elements (e.g. machines, interfaces, functions, orders, and groupings of functions, etc.) can be used instead, and some elements may be omitted altogether.

Further, many of the elements described herein are functional entities that may be implemented as discrete or distributed components or in conjunction with other components, in any suitable combination and location, and as any suitable combination of hardware, firmware, and/or software.

We claim:

1. A vehicle, comprising:
a sensor, configured to generate a plurality of frames, including a current frame;
a transceiver, configured to send the plurality of frames and messages and to receive messages;
a processor;
data storage, configured to store at least a subset of the plurality of frames; and
machine-language instructions, stored in the data storage and configured to instruct the processor to perform functions comprising:
storing a subset of the plurality of frames, including a fast-forward frame,
sending the plurality of frames, including the fast-forward frame,
receiving a lock message identifying a target feature,
determining that the lock message is associated with a fast-forward frame,
determining that the fast-forward frame is in the stored subset of frames,
determining a current location of the target feature in the current frame based on the determined target feature in the stored fast-forward frame, and
responsive to determining the current location of the target feature, sending a target-acquired message.

2. The vehicle of claim 1, wherein the machine-language instructions to determine the current location of the target feature in the current frame based on the determined target feature in the fast-forward frame are configured to instruct the processor to:
determine a latency between a control and the vehicle; and
determine the fast-forward frame based on a time of arrival of the lock message and the latency.

3. The vehicle of claim 1, wherein the lock message comprises a frame identifier.

4. The vehicle of claim 1, wherein the machine-language instructions to determine the current location of the target feature in the current frame based on the determined target feature in the fast-forward frame are configured to instruct the processor to determine the fast-forward frame based on the frame identifier.

5. The vehicle of claim 1, wherein the data storage comprises a frame buffer for storing the stored subset of frames.

6. The vehicle of claim 1, wherein the frame buffer is configured as a ring buffer.

7. The vehicle of claim 1, wherein the machine-language instructions to determine the current location of the target feature in the current frame based on the determined target feature in the fast-forward frame are configured to instruct the processor to determine a trajectory of the target feature between the fast-forward frame and the current frame.

8. The vehicle of claim 7, wherein the machine-language instructions to determine the trajectory are configured to instruct the processor to:
determine a feature value of the target feature in the fast-forward frame;
perform a gated-value search for a location of the target feature in the current frame based on the feature value; and
responsive to finding the location of the target feature in the current frame, determine the trajectory between the location of the target feature in the fast-forward frame and the location of the target feature in the current frame.

9. The vehicle of claim 1, wherein the machine-language instructions to send a target-acquired message are configured to instruct the processor to send the trajectory in the target-acquired message.

10. The vehicle of claim 1, wherein the machine-language instructions to send a target-acquired message are configured to instruct the processor to send the current position of the target feature in the current frame in the target-acquired message.

11. The vehicle of claim 1, wherein the functions further comprise:
receiving a track-target message, the track-target message comprising a feature identifier of the current feature.

12. The vehicle of claim 11, wherein the functions further comprise:
responsive to receiving the track-target message, adjusting the sensor to keep the current feature in a field of view of the sensor.

13. The vehicle of claim 11, wherein the functions further comprise:
responsive to receiving the track-target message, moving the vehicle to keep the current feature in a field of view of the sensor.

14. The vehicle of claim 1, wherein the machine language instructions to send a target-acquired message are configured to send a feature identifier for the current feature in the target-acquired message.

15. A method, comprising:
sending a first frame of a plurality of frames from a video sensor of a vehicle;
receiving the plurality of frames at a tracking unit of the vehicle;
storing a subset of the plurality of frames in the tracking unit;
receiving a lock message at the vehicle, the lock message identifying a target feature;
based on the lock message, determining a fast-forward frame in the stored subset of frames and a location of the target feature of the fast-forward frame at the vehicle;
determining a current location of the target feature based on the location of the target feature of the fast-forward frame at the vehicle; and
responsive to determining the current location of the target feature, sending a target-acquired message from the vehicle.

16. The method of claim 15, further comprising:
receiving the target-acquired message sent from the vehicle at a ground control; and
at the ground control, displaying an indication that the target feature is acquired.

17. The method of claim 15, wherein the target-acquired message comprises a target identifier, and wherein the method further comprises receiving a fire command comprising the target identifier.

18. The method of claim 17 further comprising responsive to receiving the fire command, firing a weapon based on target feature.

19. The method of claim 15, further comprising receiving a track-target command.

20. The method of claim 1, wherein determining the fast-forward frame comprises determining the fast-forward frame based on a latency estimation.
